(19) United States
(12) Patent Application Publication
(10) Pub. No.: US 2016/0205536 A1
(43) Pub. Date: Jul. 14, 2016

(54) THROUGHPUT AND MULTI-SIM CALL PERFORMANCE THROUGH EFFICIENT REUSE OF CACHED OVERHEAD INFORMATION

(71) Applicant: QUALCOMM Incorporated, San Diego, CA (US)

(72) Inventors: Bhaskara Viswanadham Batchu, Hyderabad (IN); Himanshu Agarwal, Hyderabad (IN); Sharad Shahi, Boulder, CO (US); Chintan Shirish Shah, San Diego, CA (US)

(21) Appl. No.: 14/597,093

(22) Filed: Jan. 14, 2015

(51) Int. Cl. H04W 8/18; H04L 5/00; H04B 1/3816

(52) U.S. Cl. CPC H04W 8/183; H04B 1/3816; H04L 5/0048; H04W 88/08

(57) ABSTRACT

A method includes: identifying a pilot received on a subscription utilizing a radio frequency (RF) chain of a mobile communication device having one or more parameters that correspond to at least a portion of cached overhead information for a base station (BS) previously acquired on the subscription; validating the cached overhead information that corresponds at least in part to the one or more parameters of the pilot; transitioning the subscription utilizing the RF chain to a sleep state; and releasing the RF chain from the subscription.

### BACKGROUND

Overhead messages convey detailed system configuration parameters that enable a mobile communication device to operate within a communication network. For example, a base station (BS) in a code division multiple access (CDMA) network may transmit different overhead messages on the paging channel (PCH) including, for example, but not limited to, System Parameters Message (SPM), Access Parameters Message (APM), CDMA Channel List Message (CCLM), Extended System Parameters Message (ESPM), and Neighbor List Message (NLM).

In general, when a mobile communication device acquires a communication network on a particular BS, the mobile communication device will collect the different overhead messages transmitted by the BS and cache the corresponding overhead information. A conventional mobile communication device may clear the cached overhead information when the mobile communication device attempts to reacquire the communication network. For example, cached overhead information may be cleared after the mobile communication device releases a call (e.g., voice call) on the traffic channel (TCH) and enters into a pseudo out-of-service (OOS) state. Cached overhead information may also be cleared after the mobile communication device encounters a system loss or system access failure (e.g., maximum access probe exit (MAPE)). Additionally, cached overhead information may be cleared when the mobile communication device is required to perform better service reselection (BSR).

Since cached overhead information is typically cleared, a conventional mobile communication device often needs to collect overhead messages during reacquisition of the communication network. Furthermore, a conventional mobile communication device may collect redundant overhead messages whenever the mobile communication device reacquires the communication network on a BS that the mobile communication device has previously acquired.

In a dual-subscriber identity module (SIM), dual standby (DSDS) mobile communication device, a single radio frequency (RF) chain is typically shared between two separate subscriptions. A subscription is generally unable to resume service until the necessary overhead information has been collected. The collection of overhead messages, however, may be time consuming. Thus, frequent and unnecessary collection of overhead messages may degrade the performance (e.g., impaired data throughput, mobile terminated call (MTC) failures, etc.) on one or both subscriptions. For example, activities on one subscription may be interrupted for a long period of time (e.g., 2-3 seconds) while another subscription utilizes the RF chain to collect overhead messages.

### SUMMARY

Apparatuses and methods for improving throughput and multi-SIM call performance through efficient reuse of cached overhead information are provided.

According to the various embodiments, there is provided a method. The method may include: identifying a pilot received on a subscription utilizing a RF chain of a mobile communication device having one or more parameters that correspond to at least a portion of cached overhead information for a BS previously acquired on the subscription; validating the cached overhead information that corresponds at least in part to the one or more parameters of the pilot; transitioning the subscription utilizing the RF chain to a sleep state; and releasing the RF chain from the subscription.

According to various embodiments, there is provided a method. The method may include: acquiring a communication network on a BS on a subscription utilizing an RF chain of a mobile communication device; receiving a synchronization (sync) message from the BS acquired on the subscription; identifying cached overhead information for the BS acquired on the subscription based at least in part on the sync message; in response to successfully identifying cached overhead information for the BS acquired on the subscription, validating the cached overhead information for the BS acquired on the subscription; transitioning the subscription utilizing the RF chain to a sleep state; and releasing the RF chain from the subscription.

According to the various embodiments, there is provided a mobile communication device. In some embodiments, the mobile communication device may include a control unit and an RF chain.

The control unit may be configured to: identify a pilot received on a subscription utilizing the RF chain having one or more parameters that correspond to at least a portion of cached overhead information for a BS previously acquired on the subscription; validate the cached overhead information that corresponds at least in part to the one or more parameters of the pilot; transition the subscription utilizing the RF chain to a sleep state; and release the RF chain from the subscription.

According to various embodiments, there is provided a mobile communication device. In some embodiments, the mobile communication device may include a control unit and an RF chain.

The control unit may be configured to: acquire a communication network on a BS on a subscription utilizing the RF chain; receive a sync message from the BS acquired on the subscription; identify cached overhead information for the BS acquired on the subscription based at least in part on the sync message; in response to successfully identifying cached overhead information for the BS acquired on the subscription, validate the cached overhead information for the BS acquired on the subscription; transition the subscription utilizing the RF chain to a sleep state; and release the RF chain from the subscription.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a system diagram illustrating a network environment for various embodiments;

FIG. 2 is a block diagram illustrating a mobile communication device according to various embodiments;

FIG. 3 is a flowchart illustrating a process for reusing cached overhead information according to various embodiments;

FIG. 4 is a flowchart illustrating a process for identifying a pilot having parameters that correspond to cached overhead information according to various embodiments;

FIG. 5A is a flowchart illustrating a process for validating cached overhead information according to various embodiments;

FIG. 5B is a flowchart illustrating a process for validating cached overhead information according to various embodiments;

FIG. 6 is a flowchart illustrating a process for identifying cached overhead information according to various embodiments; and

FIG. 7 is a flowchart illustrating a process for validating cached overhead information according to various embodiments.

### DETAILED DESCRIPTION

While a number of embodiments are described herein, these embodiments are presented by way of example only, and are not intended to limit the scope of protection. The apparatuses and methods described herein may be embodied in a variety of other forms. Furthermore, various omissions, substitutions, and changes in the form of the example apparatuses and methods described herein may be made without departing from the scope of protection.

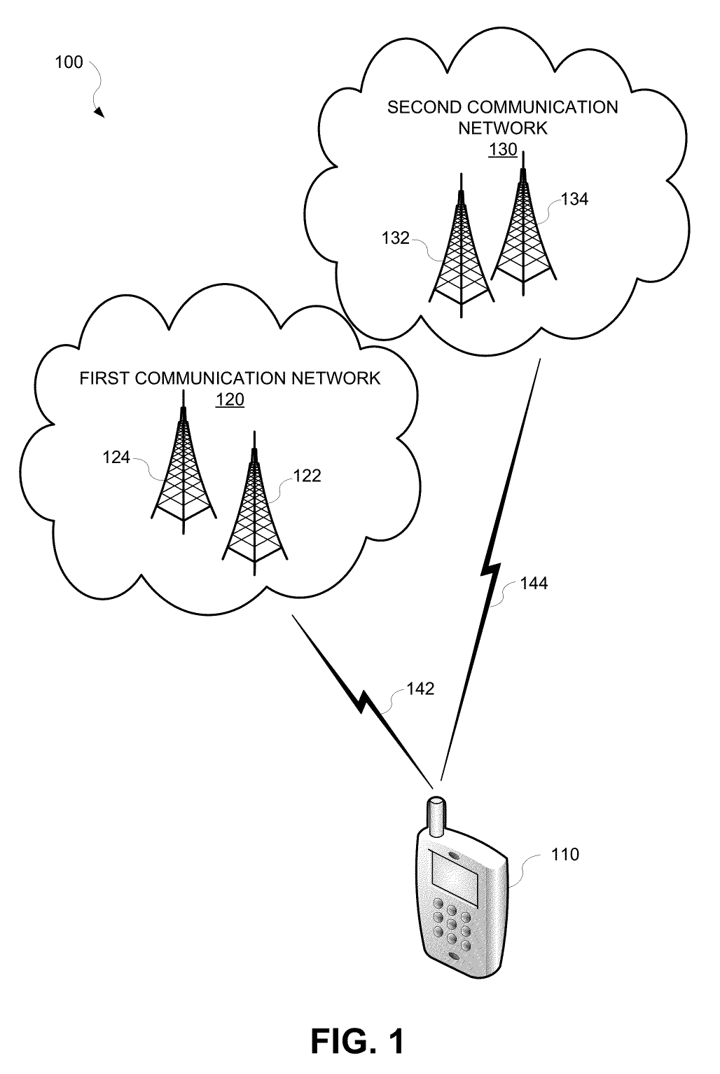

FIG. 1 is a system diagram illustrating a network environment 100 for various embodiments. Referring to FIG. 1, a mobile communication device 110 may communicate with a first communication network 120 using a first subscription 142. The mobile communication device 110 may also communicate with a second communication network 130 using a second subscription 144. In various embodiments, the first communication network 120 and the second communication network 130 may each be, for example, but not limited to, a wireless or mobile communication network.

The first communication network 120 may include a plurality of BSs including, for example, but not limited to, a first BS 122 and a second BS 124. The second communication network 130 may also include a plurality of BSs, including, for example, but not limited to, a third BS 132 and a fourth BS 134. A person of ordinary skill in the art can appreciate that the network environment 100 may include any number of communication networks, mobile communication devices, and BSs without departing from the scope of the present inventive concept.

The mobile communication device 110 may communicate with the first communication network 120 via the first BS 122. For example, the mobile communication device 110 may acquire the first communication network 120 on the first BS 122 by acquiring the pilot transmitted by the first BS 122. Neighboring BSs may be distinguished from one another based on their respective pilots. For example, the pilot transmitted by the first BS 122 may be encoded using a different pilot pseudorandom noise (PN) code than the pilot transmitted by the second BS 124.

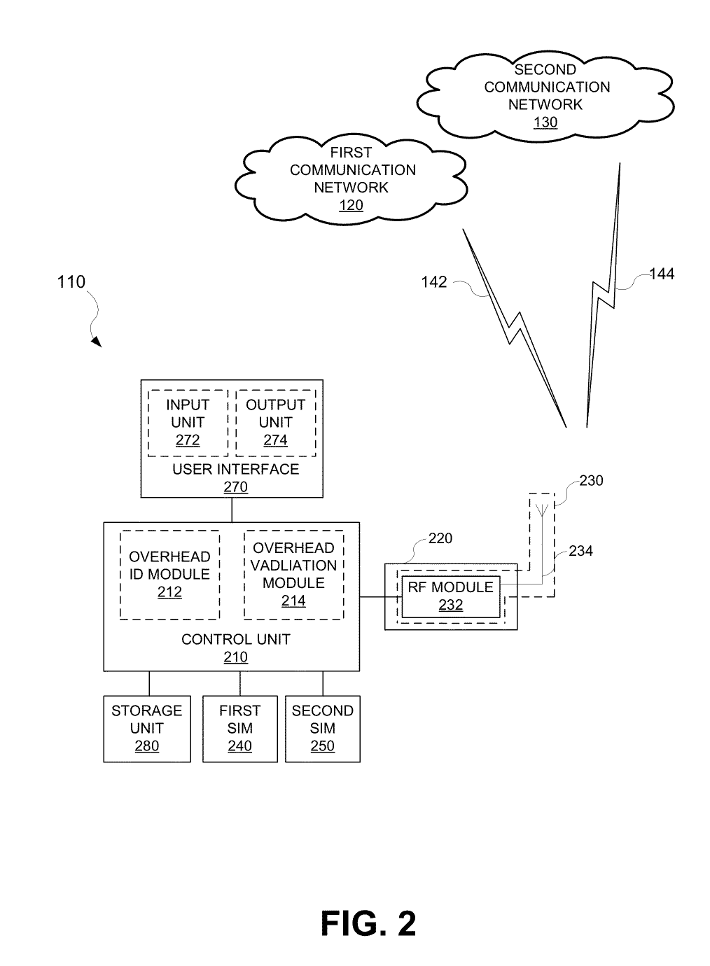

After acquiring the pilot transmitted by the first BS 122, the mobile communication device 110 may determine compatibility (e.g., hardware and/or software compatibility) with the first communication network 120 based on the sync message transmitted by the first BS 122 on the forward synchronization channel (FSYNC). If the mobile communication device 110 is compatible with the first communication network 120, a control unit (e.g., 210 in FIG. 2) may cause the mobile communication device 110 to collect overhead messages transmitted by the first BS 122. For example, the mobile communication device 110 may collect one or more of the SPM, APM, CCLM, ESPM, and NLM from the first BS 122.

In certain situations, the mobile communication device 110 may disconnect from the first BS 122 and then reacquire the first communication network 120 on the first subscription 142. The mobile communication device 110 may disconnect from the first BS 122 as a result of, for example, but not limited to, a TCH call release, system loss, system access failure (e.g., MAPE), BSR, and/or the like. The mobile communication device 110 may reacquire the first communication network 120 on the same BS or on a different BS. For example, after a TCH call release on the first subscription 142, the mobile communication device 110 may reacquire the first communication network 120 again on the first BS 122. Alternately, after performing a BSR, the mobile communication device 110 may reacquire the first communication network 120 on the second BS 124.

The mobile communication device 110 may also communicate with the second communication network 130 via the third BS 132. In various embodiments, the control unit may cause the mobile communication device 110 to acquire the second communication network 130 and collect overhead messages on the second subscription 144. For example, the mobile communication device 110 may acquire the second communication network 130 on the third BS 132. The mobile communication device 110 may later disconnect from the third BS 132, for example as a result of a MAPE, and reacquire the second communication network 130 on the fourth BS 134.

A person of ordinary skill in the art can appreciate that the communication network acquisition and overhead message collection performed on the first subscription 142 may be independent of the communication network acquisition and overhead message collection performed on the second subscription 144. Furthermore, the mobile communication device 110 may perform communication network acquisition and overhead message collection on the first subscription 142 in the same or a different manner as on the second subscription 144.

In various embodiments, the mobile communication device 110 may tune-away from the second subscription 144 to the first subscription 142, and vice versa. For example, the mobile communication device 110 may be engaged in a data call on the second subscription 144. During a tune-away, the mobile communication device 110 may acquire the first communication network 120 on the first subscription 142. In addition, the mobile communication device 110 may collect overhead messages transmitted by the first BS 122 or by the second BS 124 on the first subscription 142. During the tune-away the data call on the second subscription 144 may be deferred and may not resume until the first subscription 142 completes the acquisition of the first communication network 120 and collection of overhead messages.

FIG. 2 is a block diagram illustrating a mobile communication device 110 according to various embodiments. Referring to FIGS. 1 and 2, in various embodiments, the mobile communication device 110 may include a control unit 210, a communication unit 220, a first SIM 240, a second SIM 250, a user interface 270, and storage unit 280.

In various embodiments, the mobile communication device 110 may be any device capable of wirelessly communicating with one or more communication networks. In various embodiments, the mobile communication device 110 may be, for example, but not limited to, a smartphone, a tablet PC, or a laptop computer.

In various embodiments, the communication unit 220 may include an RF chain 230. The RF chain 230 may include, for example, but not limited to, an RF module 232 and an antenna 234. Although the mobile communication device 110 is shown to include the communication unit 220, a person of ordinary skill in the art can appreciate that the mobile communication device 110 may include additional communication units without departing from the scope of the present inventive concept.

In various embodiments, the first SIM 240 may associate the communication unit 220 with the first subscription 142 on the first communication network 120 while the second SIM 250 may associate the communication unit 220 with the second subscription 144 on the second communication network 130.

In various embodiments, the first communication network 120 and the second communication network 130 may be operated by the same or different service providers. Additionally, in various embodiments, the first communication network 120 and the second communication network 130 may each support the same or different radio access technologies (RATs), including, for example, but not limited to Wideband Code Division Multiple Access (WCDMA), Global System for Mobile communications (GSM), Long Term Evolution (LTE), and Time Division-Synchronous Code Division Multiple Access (TD-SCDMA).

In various embodiments, the user interface 270 may include an input unit 272. In some embodiments, the input unit 272 may be, for example, but not limited to, a keyboard or a touch panel. In various embodiments, the user interface 270 may include an output unit 274. In some embodiments, the output unit 274 may be, for example, but not limited to, a liquid crystal display (LCD) or a light emitting diode (LED) display. A person of ordinary skill in the art will appreciate that other types or forms of input and output units may be used without departing from the scope of the present inventive concept.

In various embodiments, the control unit 210 may be configured to control the overall operation of the mobile communication device 110 including controlling the functions of the communication unit 220. In various embodiments, the control unit 210 may include an overhead identification module 212 and an overhead validation module 214. In various embodiments, the control unit 210 may be, for example, but not limited to, a microprocessor or a microcontroller.

In various embodiments, the storage unit 280 may be configured to store application programs, application data, and user data. In various embodiments, at least some of the application programs stored at the storage unit 280 may be executed by the control unit 210 for the operation of the mobile communication device 110.

In various embodiments, the control unit 210 may be configured to cause the storage unit 280 to maintain cached overhead information for at least one BS previously acquired on the first subscription 142. For example, the control unit 210 may have previously caused the mobile communication device 110 to acquire the first communication network 120 on the first BS 122 and cache the information in the overhead messages collected from the first BS 122 in the storage unit 280. The cached overhead information for the first BS 122 is not cleared (i.e., the cached overhead information for the first BS 122 is maintained in the storage unit 280) as a result of a TCH call release, system loss, system access failure, or BSR. One of ordinary skill in the art will appreciate that cached overhead information may be maintained subsequent to other communication system events without departing from the scope of the present inventive concept.

In various embodiments, the control unit 210 may be configured to reuse cached overhead information. For example, after disconnecting from the first communication network 120 subsequent to a TCH call release, system loss, system access failure, BSR, and/or the like, the mobile communication device 110 may acquire the first communication network 120 again on the first BS 122. Since the cached overhead information for the first BS 122 is not cleared, the control unit 210 may reuse the cached overhead information for the first BS 122 and avoid collecting overhead messages from the first BS 122 again.

In various embodiments, the control unit 210 may be configured to collect overhead messages on a selective basis. For example, the mobile communication device 110 may acquire the first communication network 120 on the second BS 124. Cached overhead information for the second BS 124 may not be available if the mobile communication device 110 did not previously acquire the first communication network on the second BS 124 and collect overhead messages from the second BS 124. Alternately, the mobile communication device 110 may have acquired the first communication network on the second BS 124 and collected overhead messages from the second BS 124, but the cached overhead information for the second BS 124 may have since become stale. If the control unit 210 determines that cached overhead information for the second BS 124 is either unavailable or stale, then the mobile communication device 110 may collect overhead messages from the second BS 124.

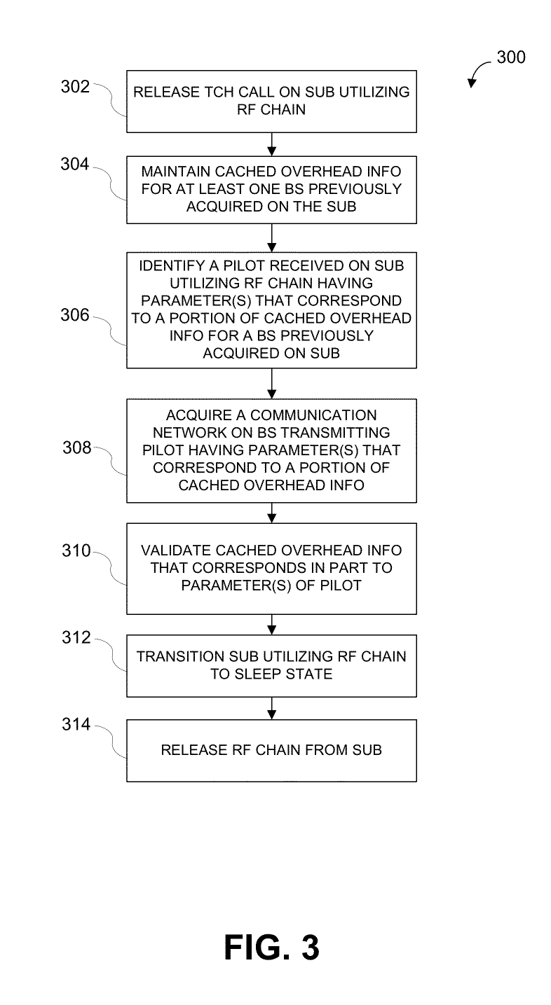

FIG. 3 is a flowchart illustrating a process 300 for reusing cached overhead information according to various embodiments. With references to FIGS. 1-3, in various embodiments, the process 300 may be performed by the control unit 210.

The control unit 210 may release a TCH call on a subscription that is utilizing an RF chain (302). For example, the mobile communication device 110 may have conducted the TCH call on the first subscription 142 via the first BS 122. After releasing the TCH call, the mobile communication device 110 may disconnect from the first BS 122. The control unit 210 may subsequently cause the mobile communication device 110 to reacquire the first communication network 120 on the first subscription 142.

In response to releasing the TCH call, the control unit 210 may maintain cached overhead information for at least one BS previously acquired on the subscription (304). For example, if the mobile communication device 110 previously acquired the first communication network 120 on the first BS 122, the control unit 210 may have cached, in the storage unit 280, information in the overhead messages collected from the first BS 122. Instead of clearing the cached overhead information for the first BS 122 from the storage unit 280 subsequent to the TCH call release, the control unit 210 may be configured to maintain the cached overhead information for the first BS 122 in the storage unit 280.

Overhead information for each BS is unique. For example, the overhead information for the first BS 122 may include parameters that are specific to the first BS 122. The parameters specific to each BS may include, for example, but not limited to, a band class, channel frequency, pilot PN code, configuration message sequence (config_msg_seq) number, system identification number (SID), network identification number (NID), and BS identification number (BSID). At least one parameter in the overhead information for the first BS 122 may be different from a corresponding parameter in the overhead information for the second BS 124. Hence, the cached overhead information for the first BS 122 may not be reused if the mobile communication device 110 acquires the first communication network 120 on the second BS 124.

The control unit 210 may identify a pilot received on the subscription utilizing the RF chain having one or more parameters that correspond to at least a portion of the cached overhead information for a BS previously acquired on the subscription (306). The control unit 210 may be configured to store the parameters of a certain number (e.g., six) pilots received on a subscription in an ASET. The pilots in the ASET may be transmitted by different BSs that are currently accessible to the mobile communication device 110 (e.g., within a reachable distance) and on which the mobile communication device 110 may acquire the first communication network 120. For example, the ASET for the first subscription 142 may include parameters for pilots transmitted by the first BS 122 and the second BS 124.

The parameters for a pilot stored in the ASET may include less than all of the parameters that may be included in the cached overhead information for the BS transmitting that pilot. For example, the parameters for the pilot transmitted by the first BS 122 may include, for example, but not limited to, a band class, channel frequency, and pilot PN code. Meanwhile, the cached overhead information for the first BS 122 may include additional parameters including, for example, but not limited to, a config_msg_seq number, NID, SID, and BSID.

Cached overhead information for a BS may correspond in part to the parameters of a pilot received on the subscription when the parameters of the pilot match at least some of the parameters included in the cached overhead information for the BS. For example, the control unit 210 may compare the band class, channel frequency, and pilot PN code of a pilot received on the first subscription 142 to the band class, channel frequency, and pilot PN code included in cached overhead information of the first BS 122. At least a portion of the cached overhead information for the first BS 122 may correspond to the parameters of a pilot received on the first subscription 142 if the band class, channel frequency, and pilot PN code included in the cached overhead information for the first BS 122 match the corresponding parameters of the pilot.

The control unit 210 may acquire a communication network on a BS transmitting the pilot having parameters that corresponds to at least a portion of the cached overhead information for a BS previously acquired on the subscription (308). For example, at least a portion of the cached overhead information for the first BS 122 may correspond to parameters of the pilot transmitted by the first BS 122. The control unit 210 may acquire the first communication network 120 on the first BS 122.

The control unit 210 may validate the cached overhead information that corresponds at least in part to the one or more parameters of the pilot (310). While the cached overhead information for a BS is unique to that BS, the parameters for the pilot transmitted by one BS may be identical to the parameters for the pilot transmitted by other BSs. For example, pilots transmitted by the first BS 122 and the second BS 124 may have the same band class, channel frequency, and pilot PN code. Thus, a portion of the cached overhead information for the first BS 122 may correspond to parameters of the pilot transmitted by the first BS 122 as well as parameters of the pilot transmitted by the second BS 124.

The control unit 210 may identify the pilot transmitted by the second BS 124 as having one or more parameters that correspond to at least a portion of the cached overhead information for the first BS 122. When the control unit 210 subsequently acquires the first communication network 120 on the second BS 124, the cached overhead information for the first BS 122 may not be reused. Thus, in order to prevent incorrect cached overhead information from being reused, the control unit 210 may validate the cached overhead information that corresponds to one or more parameters of the pilot transmitted by the BS acquired on the subscription.

The control unit 210 may subsequently transition the subscription utilizing the RF chain to a sleep state (312) and release the RF chain from the subscription (314). For example, the control unit 210 may transition the first subscription 142 to a sleep state and release the RF chain from the first subscription 142 to be utilized by the second subscription 144.

For clarity and convenience, the process 300 is described with respect to the first subscription 142. However, a person of ordinary skill in the art can appreciate that the control unit 210 may also perform the process 300 with respect to the second subscription 144 instead of or in addition to the first subscription 142 without departing from the scope of the present inventive concept.

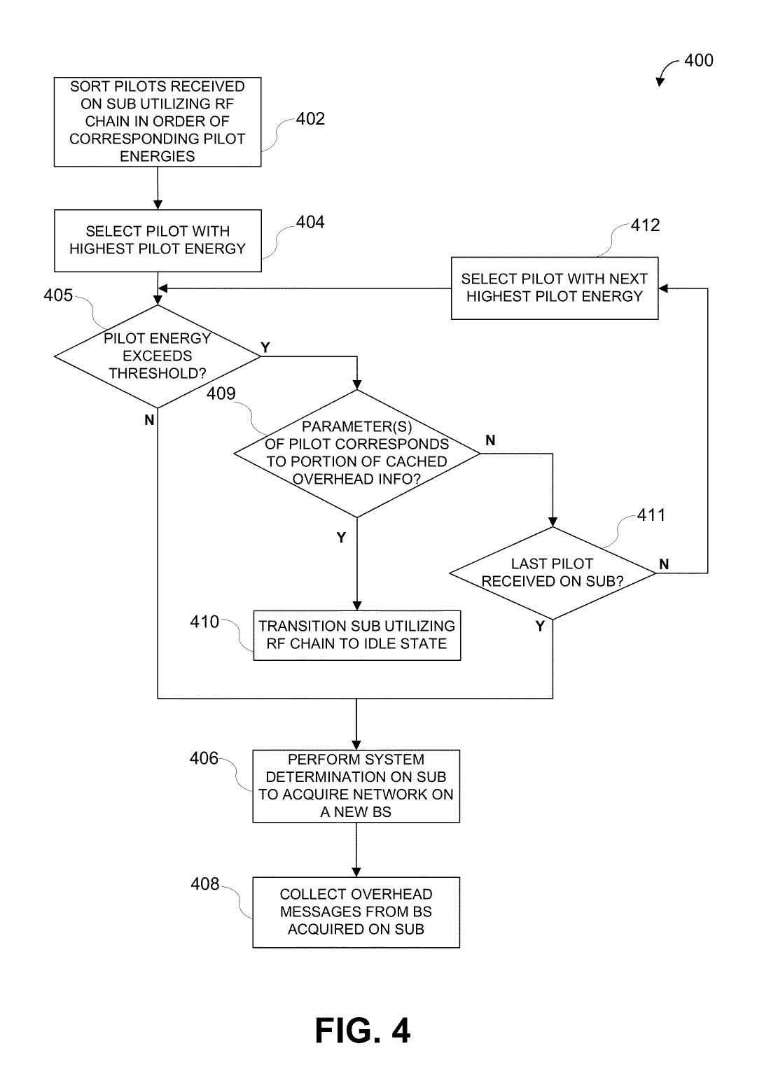

FIG. 4 is a flowchart illustrating a process 400 for identifying a pilot having parameters that correspond to cached overhead information according to various embodiments. With reference to FIGS. 1-4, in various embodiments the process 400 may be performed by the control unit 210, for example, by the overhead identification module 212, and may implement operation 306 of the process 300 (e.g., described with respect to FIG. 3).

The control unit 210 may sort the pilots received on a subscription utilizing an RF chain in an order of corresponding pilot energies (402). For example, the pilots in the ASET of the first subscription 142 may be sorted in order from highest to lowest pilot energy or in order from lowest to highest pilot energy. A person having ordinary skill in the art can appreciate that pilots may be sorted according to other pilot attributes including, for example, but not limited to, band class, channel frequency, and pilot PN code, without departing from the scope of the present inventive concept.

The control unit 210 may select a pilot with the highest pilot energy (404) and determine whether the pilot energy of that pilot exceeds a predetermined threshold (405). For example, the control unit 210 may select a pilot having the highest pilot energy from the ASET of the first subscription 142 and determine whether the pilot energy of that pilot exceeds a predetermined threshold. Pilot energy may be measured as a ratio of an average energy per PN chip (E_{c}) and a total received power density (Iₒ). For example, the control unit 210 may determine whether the pilot energy (E_{c}/Iₒ) of the pilot with the highest pilot energy in the ASET exceeds −13 decibels (dB) or another threshold.

If the pilot energy of the pilot with the highest pilot energy is determined to not exceed the predetermined threshold (405—N), the control unit 210 may perform system determination on the subscription to acquire a communication network on a new BS (406). System determination may be performed based on a Preferred Roaming List (PRL) and may include scanning for an available pilot that is not in the ASET of the subscription utilizing the RF chain. The control unit 210 may acquire the communication network on a BS that is transmitting an available pilot having the highest pilot energy. For example, the control unit 210 may perform system determination and acquire the first communication network 120 on the second BS 124. Subsequently, the control unit 210 may collect overhead messages from the BS acquired on the subscription (408). For example, the control unit 210 may collect on the first subscription 142 one or more of the SPM, APM, CCLM, ESPM, and NLM from the second BS 124.

If the pilot energy of the pilot with the highest pilot energy is determined to exceed the predetermined threshold (405—Y), the control unit 210 may determine whether one or more parameters of the pilot correspond to at least a portion of the cached overhead information for a BS previously acquired on the first subscription 142 (409). For example, to determine whether one or more parameters of the pilot received on the first subscription 142 corresponds to at least a portion of the cached overhead information for the first BS 122, the control unit 210 may compare the band class, channel frequency, and pilot PN code of the pilot to a band class, channel frequency, and pilot PN code included in the cached overhead information for the first BS 122.

If one or more parameters of the pilot are determined to correspond to at least a portion of the cached overhead information for a BS previously acquired on the subscription (409—Y), the control unit 210 may transition the subscription to an idle state (410). For example, the control unit 210 may transition the first subscription 142 to an idle state if the band class, channel frequency, and pilot PN code included in the pilot match the band class, channel frequency, and pilot PN code included in the cached overhead information for the first BS 122.

On the other hand, if one or more parameters of the pilot are determined to not correspond to at least a portion of the cached overhead information for a BS previously acquired on the subscription (409—N), the control unit 210 may determine whether the pilot is a last pilot received on the subscription (411). For example, the control unit 210 may determine whether the pilot is the last pilot in the ASET of the first subscription 142.

If the pilot is determined not to be the last pilot received on the subscription (411—N), then the control unit 210 may select a pilot received on the subscription with the next highest pilot energy (412). For example, the control unit 210 may select the pilot having the next highest pilot energy in the ASET of the first subscription 142.

Alternately, if the pilot is determined to be the last pilot received on the subscription (411—Y), then the control unit 210 may perform system determination on the subscription to acquire a communication network on a new BS (406). System determination may be performed based on a Preferred Roaming List (PRL) and may include scanning for available pilots that are not in the ASET of the subscription utilizing the RF chain. The control unit 210 may acquire the communication network on a BS that is transmitting an available pilot having the highest pilot energy. For example, the control unit 210 may perform system determination and acquire the first communication network 120 on the second BS 124. Subsequently, the control unit 210 may collect overhead messages from the BS acquired on the subscription (408). For example, the control unit 210 may collect on the first subscription 142 one or more of the SPM, APM, CCLM, ESPM, and NLM from the second BS 124.

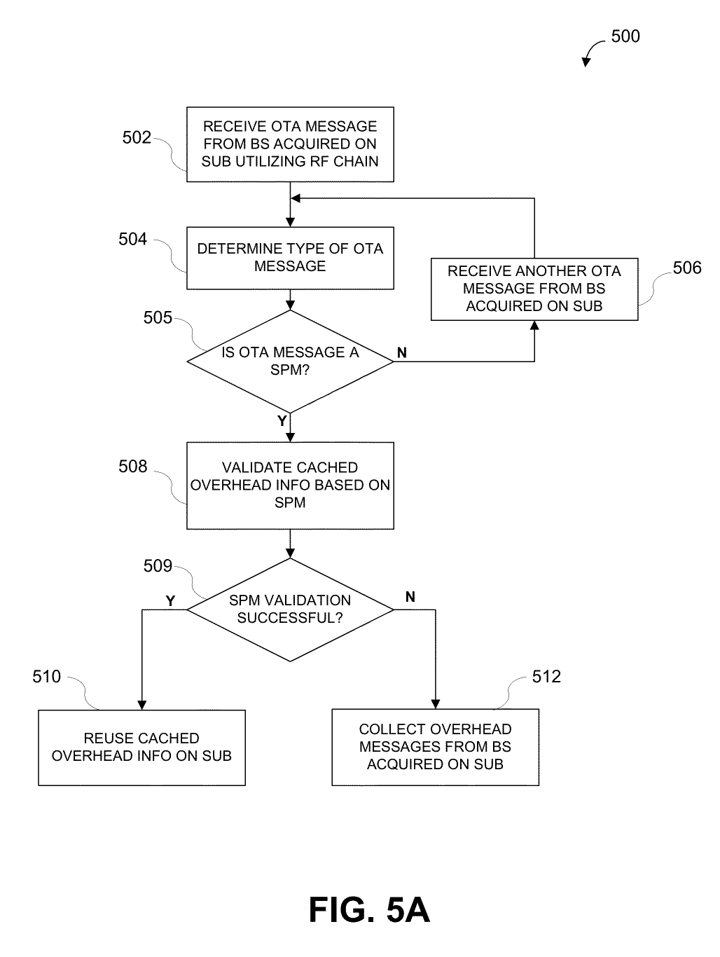

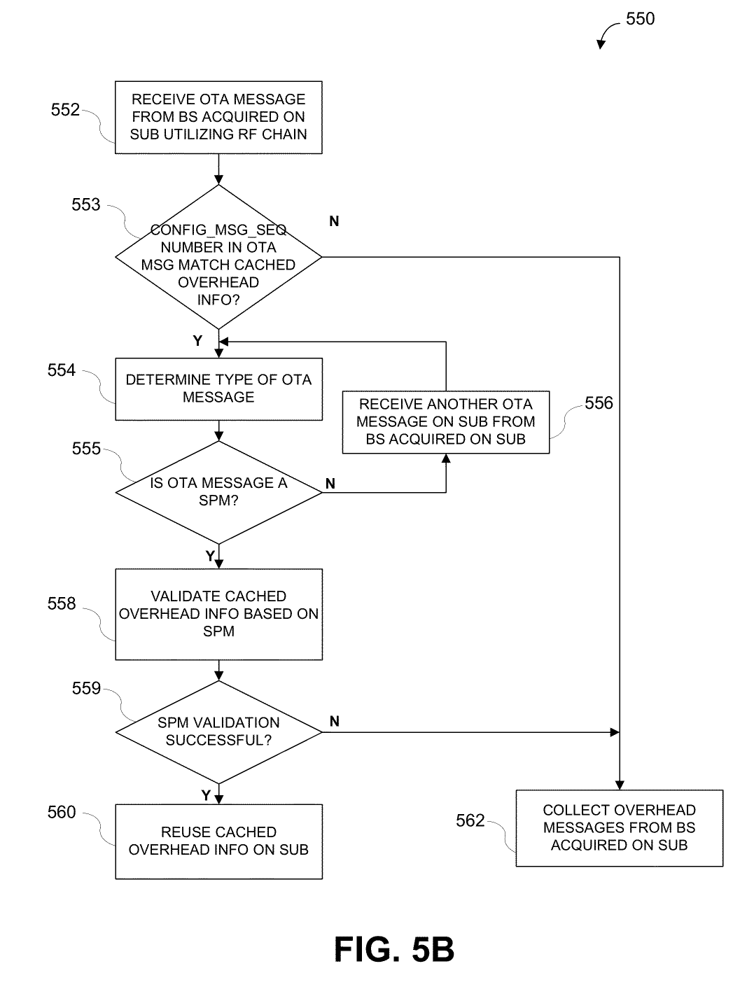

FIG. 5A is a flowchart illustrating a process 500 for validating cached overhead information according to various embodiments. Referring to FIGS. 1-5A, in various embodiments the process 500 may be performed by the control unit 210, for example, by the overhead validation module 214, and may implement operation 308 of the process 300 (e.g., described with respect to FIG. 3).

The control unit 210 may receive an over-the-air (OTA) message from a BS acquired on a subscription utilizing the RF chain (502). For example, a pilot received on the first subscription 142 having one or more parameters that correspond to at least a portion of the cached overhead information for a BS previously acquired on the first subscription 142 may be transmitted by the first BS 122. The control unit 210 may cause the mobile communication device 110 to acquire the first communication network 120 on the first BS 122 and receive an OTA message on the first subscription 142 from the first BS 122.

The control unit 210 may determine the type of the OTA message (504). If the OTA message is determined not to be an SPM (505—N), the control unit 210 may receive another OTA message from the BS acquired on the subscription (506) and again determine the type of the OTA message (504). The control unit 210 may require information from an SPM in order to validate the cached overhead information that corresponds at least in part to one or more parameters of a pilot transmitted by the BS acquired on the subscription. For example, to validate the cached overhead information, the control unit 210 may compare the config_msg_seq number, SID, NID, and BSID included in the cached overhead information to the config_msg_seq number, SID, NID, and BSID included in the SPM. Thus, the control unit 210 may be configured to continuously receive OTA messages until the receipt of an SPM.

If the OTA message is determined to be an SPM (505—Y), the control unit 210 may validate the cached overhead information based on the SPM (508). For example, the control unit 210 may compare a config_msg_seq number, SID, NID, and BSID included in the cached overhead information to a config_msg_seq number, SID, NID, and BSID included in the SPM. Cached overhead information for a BS may be reused if the control unit 210 reacquires the communication network on the same BS and overhead information for that BS has not been changed or updated. For example, the cached overhead information that corresponds at least in part to parameters of the pilot may be for the first BS 122. The control unit 210 may use the information included in the SPM to determine whether the pilot is also transmitted by the first BS 122 and that the first communication network 120 is acquired on the first BS 122.

If the cached overhead information is successfully validated based on the SPM (509—Y), the control unit 210 may reuse the cached overhead information on the subscription (510). For example, the cached overhead information that correspond s at least in part to parameters of the pilot may be for the first BS 122. Meanwhile, the pilot may be transmitted by the first BS 122 and the mobile communication device 110 may acquire the first communication network 120 on the first BS 122. The control unit 210 may determine that the config_msg_seq number, SID, NID, and BSID included in the cached overhead information for the first BS 122 match the config_msg_seq number, SID, NID, and BSID included in the SPM received from the first BS 122. As such, the control unit 210 may reuse the cached overhead information for the first BS 122 on the first subscription 142.

Alternately, the cached overhead information may not be successfully validated based on the SPM (509—N). For example, the cached overhead information that corresponds at least in part on parameters of the pilot may be for the first BS 122. However, the pilot may be transmitted by the second BS 124 and the control unit 210 may acquire the first communication network 120 on the second BS 124. In this case, the config_msg_seq number, SID, NID, and BSID included in the cached overhead information for the first BS 122 may not match the configmsg_seq number, SID, NID, and BSID included in the SPM from the second BS 124. Consequently, the control unit 210 may collect overhead messages on the subscription from the acquired BS (512). For example, For example, the control unit 210 may collect on the first subscription 142 one or more of the SPM, APM, CCLM, ESPM, and NLM from the second BS 124.

FIG. 5B is a flowchart illustrating a process 550 for validating cached overhead information according to various embodiments. Referring to FIGS. 1-4 and 5B, in various embodiments, the process 550 may be performed by the control unit 210, for example, by the overhead validation module 214, and may implement operation 308 of the process 300 (e.g., described with respect to FIG. 3).

The control unit 210 may receive an OTA message from the BS acquired on a subscription utilizing the RF chain (552). For example, the mobile communication device 110 may acquire the first communication network 120 on the first BS 120 and receive an OTA message from the first BS 122 on the first subscription 142.

Different BSs may transmit OTA messages with different config_msg_seq number. For example, OTA messages transmitted by the first BS 122 may have a different config_msg_seq number than OTA messages transmitted by the second BS 124. Furthermore, a BS may also change the config_msg_seq whenever overhead information for that BS is changed or updated. For example, each time the first BS 122 changes or updates it overhead information, the first BS 122 may increment (e.g., by one) the config_msg_seq number in its OTA messages.

A discrepancy between the config_msg_seq number found in the OTA message and the config_msg_seq number included in the cached overhead information identified as candidate overhead information may indicate that the cached overhead information identified as candidate overhead information is for a different BS than the acquired BS. Alternately, a discrepancy may indicate that the overhead information for the acquired BS has changed and that the cached overhead information for that BS is stale. Since every OTA message transmitted by a BS may include a config_msg_seq_number, the control unit 210 may eliminate incorrect or stale cached overhead information based on the config_msg_seq number without having to wait to receive an SPM.

The control unit 210 may determine whether the config_msg_seq number found in the OTA message matches the cached overhead information (553). If the config_msg_seq number found in the OTA message is determined to not match the cached overhead information (553—N), the cached overhead information may be not be for the acquired BS. Alternately, the cached overhead information may be for the acquired BS but the cached overhead information may be stale. Consequently, the control unit 210 may collect overhead messages from the BS acquired on the subscription (562). For example, if the mobile communication device acquired the first communication network 120 on the second BS 124, the control unit 210 may collect on the first subscription 142 one or more of the SPM, APM, CCLM, ESPM, and NLM from the second BS 124.

On the other hand, if config_msg_seq number found in the OTA message is determined to match the cached overhead information (553—Y), the cached overhead information may require further validation. The control unit 210 may determine the type of the OTA message (554). If the OTA message is determined not to be an SPM (555—N), the mobile communication device 110 may receive another OTA message from the BS acquired on the subscription (556) and again determine the type of the OTA message (554). The control unit 210 may require information from an SPM in order to complete validations of the cached overhead information. Thus, the control unit 210 may be configured to continuously receive OTA messages until the receipt of an SPM.

If the OTA message is determined to be an SPM (555—Y), the control unit 210 may validate the cached overhead information based on the SPM (558). For example, the SPM may include the SID, NID, and the BSID of the acquired BS. The control unit 210 may compare the SID, NID, and BSID included in the SPM and the SID, NID, and BSID included in the cached overhead information. For example, the cached overhead information may be for the first BS 122 and may not be reused if the mobile communication device 110 acquires the first communication network 120 on the second BS 124. The control unit 210 may validate the cached overhead information in order to ensure that the cached overhead information that corresponds at least in part to one or more parameters of a pilot received on the first subscription 142 is for the same BS as the BS transmitting the pilot.

If the cached overhead information is successfully validated based on the SPM (559—Y), then the control unit 210 may reuse the cached overhead information on the subscription (510). For example, cached overhead information may be reused if the cached overhead information is for the first BS 122 and the mobile communication device 110 also acquires the first communication network 120 on the first BS 122.

However, if the cached overhead information is not successfully validated based on the SPM (559—N), then the control unit 210 may collect overhead messages from the BS acquired on the subscription (562). For example, if the cached overhead information is for the first BS 122 but the mobile communication device 110 acquires the first communication network 120 on the second BS 124, the control unit 210 may collect on the first subscription 142 one or more of the SPM, APM, CCLM, ESPM, and NLM from the second BS 124.

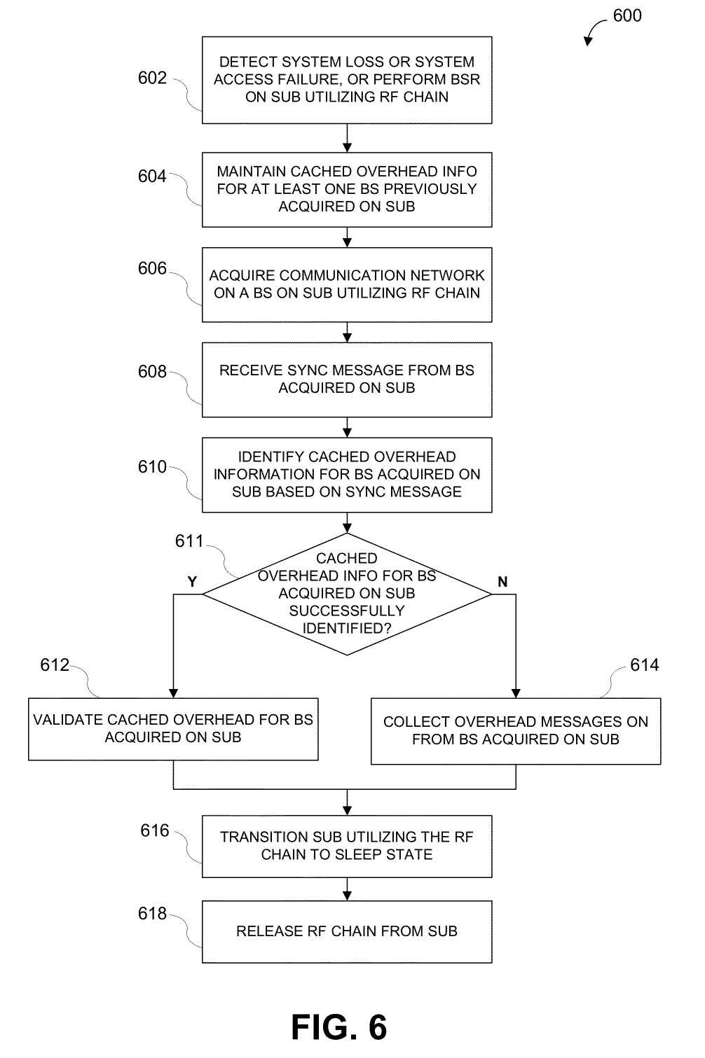

FIG. 6 is a flowchart illustrating a process 600 for identifying cached overhead information according to various embodiments. Referring to FIGS. 1, 2, and 6, in various embodiments, the process 600 may be performed by the control unit 210, for example, by the overhead identification module 212.

The control unit 210 may detect a system loss or a system access failure (e.g., MAPE), or may be required to perform a BSR on a subscription utilizing the RF chain (602). In response to detecting the system loss or system access failure, or to preforming the BSR, the control unit 210 may be configured to maintain, in the storage unit 280, cached overhead information for at least one BS previously acquired on the subscription (604). For example, the mobile communication device 110 may have acquired the first communication network 120 on the first subscription 142 on the first BS 122. The first communication network 110 may have cached, in the storage unit 280, information in the overhead messages collected from the first BS 122. The cached overhead information for the first BS 122 is not cleared from the storage unit 280 as a result of the system loss, system access failure, or BSR.

The control unit 210 may acquire a communication network on a BS on the subscription utilizing the RF chain (606). For example, the control unit 210 may perform system determination to acquire the first communication network 120 on the first BS 122. System determination may be performed based on a PRL and may include scanning for a pilot having the strongest pilot energy available. The mobile communication device 110 may acquire the first communication network 120 on the first BS 122 if the first BS 122 is transmitting the pilot having the strongest pilot energy.

Subsequently, the control unit 210 may receive a sync message from the BS acquired on the subscription utilizing the RF chain (608). For example, the control unit 210 may receive a sync message from the first BS 122 on the first subscription 142. The sync message may include parameters for the acquired BS including, for example, but not limited to a band class, channel frequency, pilot PN code, SID, and NID.

The control unit 210 may identify cached overhead information for the BS acquired on the subscription based on the sync message (610). Cached overhead information for the acquired BS may be identified based on the sync message received from the acquired BS. For example, the control unit 210 may compare the parameters in the sync message from the first BS 122 with at least some of the parameters in the cached overhead information for at least one BS previously acquired on the first subscription 142. The control unit may compare the band class, channel frequency, pilot PN code, SID, and NID included in the sync message with the band class, channel frequency, pilot PN code, SID, and NID included in the cached overhead information for at least one BS previously acquired on the first subscription 142.

If the control unit 210 successfully identifies cached overhead information for the BS acquired on the subscription (611—Y), the control unit 210 may validate the cached overhead information for the BS acquired on the subscription (612). For example, the mobile communication device 110 may have acquired the first communication network 120 on the first BS 122. The control unit may successfully identify cached overhead information for the first BS 122 if the band class, channel frequency, pilot PN code, SID, and NID in the sync message from the first BS 122 match the corresponding parameters in the cached overhead information for at least one BS previously acquired on the first subscription 142. However, the control unit 210 may still need to validate the cached overhead information for the first BS 122 in order to ensure that the cached overhead information is not stale.

The control unit 210 may subsequently transition the subscription utilizing the RF chain to a sleep state (616) and release the RF chain from the subscription (618). For example, the control unit 210 may transition the first subscription 142 to a sleep state and release the RF chain from the first subscription 142 to be utilized by the second subscription 144.

Alternately, if cached overhead information for the BS acquired on the subscription is not successfully identified (611—N), the control unit 210 may collect overhead messages from the BS acquired on the subscription (614). For example, the mobile communication device 110 may not have previously acquired the first communication network 120 on the second BS 124 or collected overhead messages from the second BS 124. Thus, the parameters in the sync message may not match the parameters of the cached overhead information for any of the BSs previously acquired on the first subscription 142. In this case, the control unit 210 may collect on the first subscription 142 one or more of the SPM, APM, CCLM, ESPM, and NLM from the second BS 124.

The control unit 210 may then transition the subscription utilizing the RF chain to a sleep state (616) and release the RF chain from the subscription (618). For example, the control unit 210 may transition the first subscription 142 to a sleep state and release the RF chain from the first subscription 142 to be utilized by the second subscription 144.

Although the process 600 is described with respect to the first subscription 142, a person of ordinary skill in the art can appreciate that the control unit 210 may also perform the process 600 with respect to the second subscription 144 instead of or in addition to the first subscription 142 without departing from the scope of the present inventive concept.

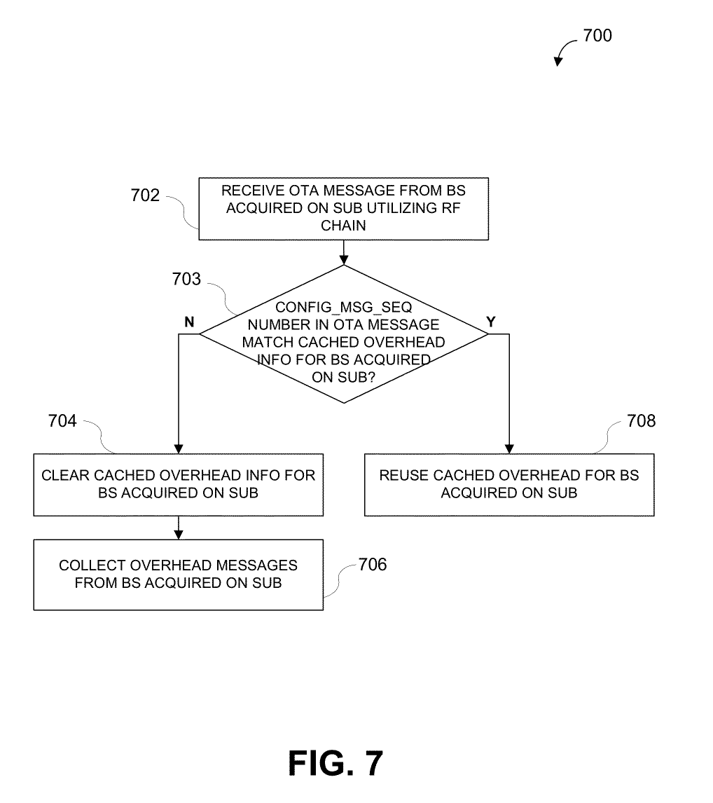

FIG. 7 is a flowchart illustrating a process 700 for validating cached overhead information according to various embodiments. With reference to FIGS. 1, 2, 6, and 7, in various embodiments, the process 700 may be performed by the control unit 210, for example, by the overhead validation module 214, and may implement operation 610 of the process 600 described with respect to FIG. 6.

The control unit 210 may receive an OTA message from a BS acquired on a subscription utilizing the RF chain (702). The control unit 210 may determine whether the config_msg_seq number found in the OTA message matches the cached overhead information for the BS acquired on the subscription (703). For example, the mobile communication device 110 may have acquired the first communication network 120 on the first subscription 142 on the first BS 122. As such, the control unit 210 may receive an OTA message on the first subscription 142 from the first BS 122.

The acquired BS may change the config_msg_seq whenever overhead information for that BS is changed or updated. For example, each time the first BS 122 changes or updates it overhead information, the first BS 122 may increment (e.g., by one) the config_msg_seq number in its OTA messages. A discrepancy between the config_msg_seq number included in the cached overhead information for the acquired BS and the config_msg_seq number found in the OTA message received from the acquired BS may indicate that the overhead information for the acquired BS has changed and that the cached overhead information for the acquired BS is stale.

If the config_msg_seq number found in the OTA message is determined to not match the cached overhead information for the BS acquired on the subscription (703—N), the cached overhead information for the acquired BS may be stale. The control unit 210 may clear the cached overhead information for the BS acquired on the subscription (706). For example, the control unit 210 may clear the cached overhead information for the first BS 122 if the config_msg_seq number included in the cached overhead information for the first BS 122 does not match the config_msg_seq number in the OTA message received from the first BS 122.

The control unit 210 may subsequently collect overhead messages from the BS acquired on the subscription (706). For example, after the control unit determines that the cached overhead information for the first BS 122 is stale and clears the cached overhead information for the first BS 122, the control unit 210 may collect on the first subscription 142 one or more of the SPM, APM, CCLM, ESPM, and NLM from the first BS 122.

Alternately, if the config_msg_seq number found in the OTA is determined to match the cached overhead information for the BS acquired on the subscription (703—Y), the control unit 210 may reuse the cached overhead information for the BS acquired on the subscription (708). For example, the control unit 210 may reuse the cached overhead information for the first BS 122 on the first subscription 142 if the config_msg_seq number found in the OTA received from the first BS 122 matches the config_msg_seq number in the cached overhead information for the first BS 122.

The accompanying claims and their equivalents are intended to cover such forms or modifications as would fall within the scope and spirit of the protection. For example, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method, comprising:
identifying a pilot received on a subscription utilizing a radio frequency (RF) chain of a mobile communication device having one or more parameters that correspond to at least a portion of cached overhead information for a base station (BS) previously acquired on the subscription;
validating the cached overhead information that corresponds at least in part to the one or more parameters of the pilot;
transitioning the subscription utilizing the RF chain to a sleep state; and
releasing the RF chain from the subscription.

2. The method of claim 1, wherein the one or more parameters of the pilot received on the subscription are stored in an active set (ASET) of the subscription.

3. The method of claim 1, further comprising:
releasing a traffic channel (TCH) call on the subscription; and
in response to releasing the TCH call, maintaining cached overhead information for at least one BS previously acquired on the subscription.

4. The method of claim 1, wherein identifying a pilot received on the subscription having one or more parameters that correspond to at least a portion of cached overhead information for a BS previously acquired on the subscription comprises:
sorting a plurality of pilots received on the subscription in an order of pilot energy;
selecting one of the plurality of pilots having a highest pilot energy;
determining whether the pilot energy of the one of the plurality of pilots having a highest pilot energy exceeds a predetermined threshold; and
in response to a determination that the pilot energy of the one of the plurality of pilots exceeds the predetermined threshold, determining whether one or more parameters of the one of the plurality of pilots corresponds to at least a portion of cached overhead information for a BS previously acquired on the subscription.

5. The method of claim 4, further comprising transitioning the subscription utilizing the RF chain to an idle state in response to a determination that one or more parameters of the one of plurality of pilots correspond to at least a portion of cached overhead information for a BS previously acquired on the subscription.

6. The method of claim 4, wherein determining whether the one or more parameters of the one of the plurality of pilots correspond to at least a portion of the cached overhead information for a BS previously acquired on the subscription includes comparing at least one of a band class, a channel frequency, and a pilot PN code comprising the one or more parameters and a band class, a channel frequency, and a pilot PN code comprising at least a portion of the cached overhead information for at least one BS previously acquired on the subscription.

7. The method of claim 4, further comprising, in response to a determination that the pilot energy of the one of the plurality of pilots does not exceed the predetermined threshold:
performing system determination on the subscription to acquire a communication network on a new BS; and
collecting overhead messages from the BS acquired on the subscription.

8. The method of claim 4, further comprising determining whether the one of the plurality of pilots is a last pilot received on the subscription in response to a determination that the one or more parameters of the one of the plurality of pilots do not correspond to at least a portion of the cached overhead information for a BS previously acquired on the subscription.

9. The method of claim 8, further comprising in response to a determination that the one of the plurality of pilots is the last pilot received on the subscription:
performing system determination on the subscription to acquire a communication network on a new BS; and
collecting overhead messages from the BS acquired on the subscription.

10. The method of claim 8, further comprising selecting one of the plurality of pilots received on the subscription having a next highest pilot energy in response to a determination that the one of the plurality of pilots is not the last pilot received on the subscription.

11. The method of claim 1, further comprising acquiring a communication network on a BS transmitting the pilot having one or more parameters that corresponds to at least a portion of the cached overhead information for a BS previously acquired on the subscription.

12. The method of claim 11, wherein validating the cached overhead information that corresponds at least in part on one or more parameters of the pilot comprises:
receiving an over-the-air (OTA) message from the BS acquired on the subscription;
determining whether a configuration message sequence number included in the OTA message matches the cached overhead information; and
in response to a determination that the configuration message sequence number included in the OTA message matches the cached overhead information, determining a type of the OTA message.

13. The method of claim 12, further comprising collecting overhead messages from the BS acquired on the subscription in response to a determination that the configuration message sequence number included in the OTA does not match the cached overhead information.

14. The method of claim 12, further comprising in response to a determination that the OTA message is an SPM, validating the cached overhead information based at least in part on the SPM, wherein validating the cached overhead information based on the SPM includes comparing a system identification number (SID), a network identification number (NID), and a BS identification number (BSID) included in the SPM, and a SID, a NID, and a BSID included in the cached overhead information.

15. The method of claim 14, further comprising reusing the cached overhead information on the subscription in response to a successful validation of the cached overhead information based on the SPM.

16. The method of claim 14, further comprising collecting overhead messages from the BS acquired on the subscription in response to an unsuccessful validation of the cached overhead information based on the SPM.

17. The method of claim 12, further comprising receiving another OTA message from the BS acquired on the subscription in response to a determination that the OTA message is not an SPM.

18. A method, comprising:
acquiring a communication network on a base station (BS) on a subscription utilizing a radio frequency (RF) chain of a mobile communication device;
receiving a synchronization (sync) message from the BS acquired on the subscription;
identifying cached overhead information for the BS acquired on the subscription based at least in part on the sync message;
in response to successfully identifying cached overhead information for the BS acquired on the subscription, validating the cached overhead information for the BS acquired on the subscription;
transitioning the subscription utilizing the RF chain to a sleep state; and
releasing the RF chain from the subscription.

19. The method of claim 18, further comprising:
detecting a system loss or a system access failure, or performing a better service reselection (BSR) on the subscription utilizing the RF chain; and
in response to detecting the system loss or system access failure, or to performing the BSR, maintaining cached overhead information for at least one BS previously acquired on the subscription.

20. The method of claim 18, further comprising collecting overhead messages from the BS acquired on the subscription in response to an unsuccessful identification of cached overhead information for the BS acquired on the subscription.

21. The method of claim 18, wherein validating the cached overhead information for the BS acquired on the subscription comprises:
receiving an over-the-air (OTA) message from the BS acquired on the subscription;
determining whether a configuration message sequence number included in the OTA message matches the cached overhead information; and
in response to a determination that the configuration message sequence number included in the OTA message matches the cached overhead information for the BS acquired on the subscription, reusing the cached overhead information for the BS acquired on the subscription.

22. The method of claim 21, further comprising in response to a determination that the configuration message sequence number included in the OTA message does not match the cached overhead information for the BS acquired on the subscription:
clearing the cached overhead information for the BS acquired on the subscription; and
collecting overhead messages from the BS acquired on the subscription.

23. A mobile communication device, comprising:
a radio frequency (RF) chain; and
a control unit configured to:
identify a pilot received on a subscription utilizing the RF chain having one or more parameters that correspond to at least a portion of cached overhead information for a base station (BS) previously acquired on the subscription;
validate the cached overhead information that corresponds at least in part to the one or more parameters of the pilot;
transition the subscription utilizing the RF chain to a sleep state; and
release the RF chain from the subscription.

24. The mobile communication device of claim 23, wherein one or more parameters of at least one pilot received on the subscription are stored in an active set (ASET) of the subscription.

25. The mobile communication device of claim 23, wherein the control unit is further configured to:
release a traffic channel (TCH) call on the subscription; and
in response to releasing the TCH call, maintain cached overhead information for at least one BS previously acquired on the subscription.

26. The mobile communication device of claim 23, wherein to identify the cached overhead information of a BS as candidate overhead information, the control unit is configured to:
sort a plurality of pilots received on the subscription in an order of pilot energy;
select one of the plurality of pilots having a highest pilot energy;
determine whether the pilot energy of the one of the plurality of pilots having a highest pilot energy exceeds a predetermined threshold;
in response to a determination that the pilot energy of the one of the plurality of pilots exceeds the predetermined threshold, determine whether one or more parameters of the one of the plurality of pilots corresponds to at least a portion of cached overhead information for a BS previously acquired on the subscription.

27. The mobile communication device of claim 26, wherein the control unit is further configured to transition the subscription utilizing the RF chain to an idle state in response to a determination that one or more parameters of the one of the plurality of pilots correspond to at least a portion of the cached overhead information for a BS previously acquired on the subscription.

28. A mobile communication device, comprising:
a radio frequency (RF) chain; and
a control unit configured to:
acquire a communication network on a base station (BS) on a subscription utilizing the RF chain;
receive a synchronization (sync) message from the acquired BS on the subscription;
identify cached overhead information for the BS acquired on the subscription based at least in part on the sync message;
in response to successfully identifying cached overhead information for the BS acquired on the subscription, validate the cached overhead information for the BS acquired on the subscription;
transition the subscription utilizing the RF chain to a sleep state; and
release the RF chain from the subscription.
